(19) United States
(12) Patent Application Publication
(10) Pub. No.: US 2021/0347221 A1
(43) Pub. Date: Nov. 11, 2021

(54) APPARATUS AND METHOD FOR CONTROLLING SUSPENSION OF VEHICLE

(71) Applicants: HYUNDAI MOTOR COMPANY, Seoul (KR); KIA MOTORS CORPORATION, Seoul (KR)

(72) Inventors: Jae Hyung PARK, Seoul (KR); Woo Sung LEE, Seoul (KR); Eun Woo NA, Suwon-si (KR)

(21) Appl. No.: 17/016,815

(22) Filed: Sep. 10, 2020

(30) Foreign Application Priority Data
May 6, 2020 (KR) 10-2020-0053891

(51) Int. Cl. B60G 17/0165; B60G 17/016; B60G 17/019; B60G 17/0195; B60R 16/00

(52) U.S. Cl. CPC B60G 17/0165; B60G 17/0162; B60G 17/019; B60G 17/0195; B60G 2800/24; B60G 2400/104; B60G 2400/82; B60G 2400/843; B60G 2500/30; B60R 16/005

(57) ABSTRACT

An apparatus for controlling a suspension of a vehicle includes: the electronically controlled suspension arranged between wheels and a vehicle body and configured to increase or decrease a contact force between a tire of the vehicle and a road surface; and a controller that adjusts a height of the vehicle depending on a type of road when it rains and adjusts an operating time of the suspension based on a lateral acceleration of the vehicle.

### CROSS-REFERENCE TO RELATED APPLICATION

This application claims the benefit of priority to Korean Patent Application No. 10-2020-0053891, filed in the Korean Intellectual Property Office on May 6, 2020, the entire contents of which are incorporated herein by reference.

### TECHNICAL FIELD

The present disclosure relates to a technology for improving a contact force between a tire of a vehicle and a road surface when it rains.

### BACKGROUND

In general, suspension of a vehicle absorbs shock from a road surface to improve ride comfort, driving stability, and cornering characteristics. A large vehicle (e.g., a bus) or a luxury vehicle is equipped with air suspension.

The air suspension uses an air spring using the elasticity of compressed air and therefore offers excellent ride comfort due to its flexible elastic action while absorbing micro vibration. Furthermore, because the pressure of the compressed air injected into the air spring is adjusted, the air suspension may uniformly maintain the height of the vehicle (hereinafter, referred to as the vehicle height) irrespective of loads, thus contributing to high quality of the vehicle. Recently, air suspension has been increasingly applied to various fields such as recreational vehicles.

Air suspension has a structure in which a damper is located inside and a tubular air spring into which air is injected is located outside.

The air suspension may not only serve as a hydraulic damper in which fluid resistance is generated while fluid compressed by external shock moves through a minute tube and fluid flow resistance and a valve formed on a flow path interfere with the flow of the fluid to firstly absorb the shock, but may also serve as an air spring in which the pressure of air injected into an elastic tube absorbs part of the shock applied to the damper. Thus, the air suspension offers better ride comfort and driving stability.

That is, a large portion of primary and direct shock is absorbed by the air spring, and sudden action of micro vibration or damping force, which is a disadvantage of the air spring, may be offset or compensated by the hydraulic damper.

When it rains, a hydroplaning phenomenon that decreases a contact force between a tire of a vehicle and a road surface occurs. The hydroplaning phenomenon may cause a vehicle accident by lowering braking performance as well as steering performance of the vehicle.

To solve the hydroplaning phenomenon, a driver has to directly inject air into the tire. However, the driver cannot inject air into the tire of the vehicle while driving the vehicle. Accordingly, a method of solving the hydroplaning phenomenon in a different way is required.

The above information disclosed in this Background section is only for enhancement of understanding of the background of the present disclosure and therefore it may contain information that does not form any part of the prior art nor what the prior art may suggest to a person of ordinary skill in the art.

### SUMMARY

The present disclosure has been made to solve the above-mentioned problems occurring in the prior art while advantages achieved by the prior art are maintained intact.

An aspect of the present disclosure provides a vehicle suspension control apparatus and method for improving a contact force between a tire of a vehicle and a road surface when it rains, by adjusting the height of the vehicle (the vehicle height) depending on the type of road when it rains, operating suspension in a soft mode when the vehicle travels straight ahead, operating the suspension in a hard mode when the vehicle turns a corner, and adjusting operating time of the suspension based on lateral acceleration of the vehicle.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling suspension of a vehicle includes electronically controlled suspension arranged between wheels and a vehicle body and configured to increase or decrease a contact force between a tire of the vehicle and a road surface; and a controller configured to adjust a height of the vehicle depending on a type of road when it rains and to adjust an operating time of the suspension based on a lateral acceleration of the vehicle.

The controller may adjust the height of the vehicle by transferring a first adjustment value to the suspension when the vehicle travels on a high-speed road in the event of rain and transferring a second adjustment value (a value being lower than the first adjustment value) to the suspension when the vehicle travels on a low-speed road in the event of rain.

The controller may adjust hard-mode operating time of the suspension based on the lateral acceleration of the vehicle when the vehicle travels on a curved road in the event of rain.

The controller may set a reference value that is lower than that at ordinary time and may operate the suspension in a hard mode earlier than usual, when the vehicle travels on a curved road in the event of rain.

The apparatus may further include a rain sensor that outputs a rain signal when drops of water are detected on windshield glass of the vehicle, and the controller may determine whether it rains, based on the rain signal from the rain sensor.

The apparatus may further include a rain sensor that outputs a rain signal when drops of water are detected on windshield glass of the vehicle and a multi-function switch that outputs a wiper operating signal, and the controller may determine whether it rains, based on the rain signal from the rain sensor and the wiper operating signal from the multi-function switch.

The apparatus may further include a rain sensor that outputs a rain signal when drops of water are detected on windshield glass of the vehicle and a multi-function switch that outputs a wiper operating signal and a washer-fluid dispensing signal, and the controller may determine whether it rains, based on the rain signal from the rain sensor and the wiper operating signal and the washer-fluid dispensing signal from the multi-function switch.

The controller may collect, from a navigation device, information about a road on which the vehicle travels.

The controller may calculate the lateral acceleration by using speed, steering angle, and angular velocity of the vehicle obtained through a vehicle network.

According to another aspect of the present disclosure, a method for controlling a suspension of a vehicle includes determining whether it rains, adjusting a height of the vehicle depending on a type of road when it rains, and adjusting an operating time of the suspension based on a lateral acceleration of the vehicle.

The adjusting of the height of the vehicle may include adjusting the height of the vehicle by transferring a first adjustment value to the suspension, when the vehicle travels on a high-speed road in the event of rain and adjusting the height of the vehicle by transferring a second adjustment value to the suspension, when the vehicle travels on a low-speed road in the event of rain.

The adjusting of the operating time of the suspension may include adjusting hard-mode operating time of the suspension based on the lateral acceleration of the vehicle, when the vehicle travels on a curved road in the event of rain.

The adjusting of the operating time of the suspension may include setting a reference value that is lower than that at ordinary time and operating the suspension in a hard mode earlier than usual, when the vehicle travels on a curved road in the event of rain.

The determining of whether it rains may include determining whether it rains, based on a rain signal from a rain sensor.

The determining of whether it rains may include determining whether it rains, based on a rain signal from a rain sensor and a wiper operating signal from a multi-function switch.

The determining of whether it rains may include determining whether it rains, based on a rain signal from a rain sensor and a wiper operating signal and a washer-fluid dispensing signal from a multi-function switch.

The adjusting of the height of the vehicle may include collecting, from a navigation device, information about a road on which the vehicle travels.

The adjusting of the operating time of the suspension may include calculating the lateral acceleration by using speed, steering angle, and angular velocity of the vehicle obtained through a vehicle network.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a configuration of a vehicle suspension control apparatus according to an embodiment of the present disclosure;

FIG. 2 is a view illustrating a configuration of an electronically controlled suspension used in the present disclosure;

FIG. 3 is a flowchart illustrating a vehicle suspension control method according to an embodiment of the present disclosure; and

FIG. 4 is a block diagram illustrating a computing system for executing the vehicle suspension control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

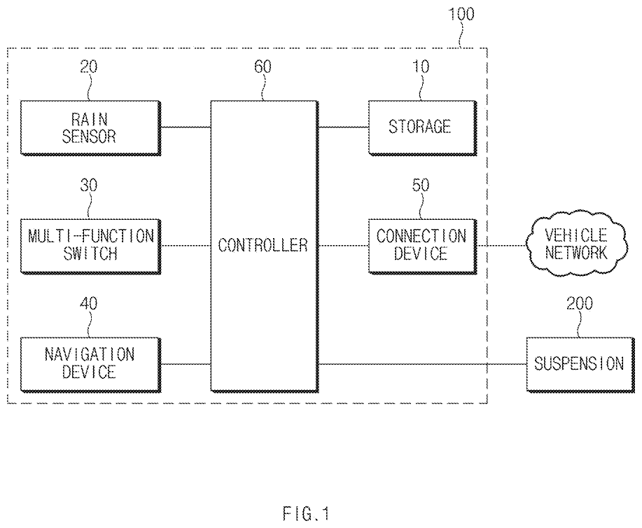

FIG. 1 is a view illustrating a configuration of a vehicle suspension control apparatus according to an embodiment of the present disclosure.

As illustrated in FIG. 1, the vehicle suspension control apparatus 100 according to the embodiment of the present disclosure may include storage 10, a rain sensor 20, a multi-function switch 30, a navigation device 40, a connection device 50, and a controller 60. Depending on a way of carrying out the vehicle suspension control apparatus 100 according to the embodiment of the present disclosure, the components may be combined together to form one entity or some of the components may be omitted.

The storage 10 may store various types of logics, algorithms, and programs required for a process of adjusting the height of a vehicle (the vehicle height) depending on the type of road when it rains, operating suspension 200 in a soft mode when the vehicle travels straight ahead, operating the suspension 200 in a hard mode when the vehicle turns a corner, and adjusting operating time of the suspension 200 based on lateral acceleration of the vehicle.

The storage 10 may store a vehicle height adjustment value (e.g., −30 mm) that is applied when the vehicle travels on a high-speed road in the event of rain and a vehicle height adjustment value (e.g., −15 mm) that is applied when the vehicle travels on a low-speed road in the event of rain. Here, the high-speed road refers to a road where the speed limit exceeds a reference value (e.g., 80 kph), and the low-speed road refers to a road where the speed limit is lower than the reference value. Furthermore, when the vehicle height adjustment value has a minus (−) value, it means that the vehicle height is decreased.

The storage 10 may store a reference value used to determine time to operate the suspension 200 in the hard mode when the vehicle turns a corner. The reference value may be, for example, a lateral acceleration value of the vehicle, and the lateral acceleration value of the vehicle may include a reference value (e.g., 3G) that is applied in the event of rain and a reference value (e.g., 5G) that is applied at ordinary time.

The storage 10 may include at least one type of storage medium among memories of a flash memory type, a hard disk type, a micro type, and a card type (e.g., a Secure Digital (SD) card or an eXtream Digital (XD) card) or memories of a Random Access Memory (RAM) type, a Static RAM (SRAM) type, a Read-Only Memory (ROM) type, a Programmable ROM (PROM) type, an Electrically Erasable PROM (EEPROM) type, a Magnetic RAM (MRAM) type, a magnetic disk type, and an optical disk type.

The rain sensor 20 may be a sensor that senses the amount of rainwater that falls on the windshield glass of the vehicle. The rain sensor 20 may include a light emitting part (not illustrated) that emits light and a light receiving part (not illustrated) that receives the light emitted from the light emitting part.

The rain sensor 20 may include an Infrared (IR) Light Emitting Diode (LED) that irradiates infrared light to the surface of the windshield glass, as the light emitting part. The rain sensor 20 may include a Photo Diode (PD) that detects the infrared light emitted from the LED and reflected from the surface of the windshield glass, as the light receiving part. The rain sensor 20 may include a lens installed between the LED and the windshield glass and a lens installed between the PD and the windshield glass. The PD outputs an electrical signal depending on the amount of detected reflective light, that is, the amount of infrared light (reflective light) reflected from the surface of the windshield glass after emitted from the LED. When drops of water (drops of rain) exist on the surface of the windshield glass, the reflectance of the infrared light is varied by the drops of water, or the infrared light is oriented in a different direction by refraction, and therefore the amount of light detected by the PD differs from the amount of light in a normal case in which drops of water do not exist on the surface of the windshield glass. Accordingly, a presence or absence of drops of water, the amount of drops of water attached, and a rainfall level maybe determined based on the difference between the amount of light detected and the amount of light in the normal case in which drops of water do not exist on the surface of the windshield glass.

The multi-function switch 30 may operate a wiper used to remove drops of water formed on the windshield glass of the vehicle, may dispense washer fluid onto the windshield glass of the vehicle, or may adjust the speed of the wiper.

The multi-function switch 30, which is a part fastened to a steering column below a steering wheel of the vehicle, may include a body having a cancel cam and a horn mounted therein, a left lever that performs a switch function for a turn signal and a lamp, and a right lever including a wiper and washer-fluid dispensing switch function and an intermittent wiping switch function.

The navigation device 40 may provide information about a road (e.g., a high-speed road, a low-speed road, a straight road, or a curved road) on which the vehicle travels.

The navigation device 40 may include a GPS module that receives a Global Positioning System (GPS) signal from a satellite and generates first vehicle position data of the navigation device 40 based on the received GPS signal, a Dead-Reckoning (DR) sensor that generates second vehicle position data based on the travel direction of the vehicle and the speed of the vehicle, storage (or, a memory) that stores map data and various pieces of information, a map matching device that generates an estimated position of the vehicle based on the first vehicle position data and the second vehicle position data, matches the estimated position of the vehicle and a link (a map matching link or a map matching road) in the map data, and outputs the matched map information (a map matching result), a communication device that performs telephone communication through a wireless communication network, a controller that generates road guidance information based on the matched map information (the map matching result), generates and transmits information about a state (e.g., a dangerous state or a breakdown state) of a surrounding vehicle, or receives information about a state of a host vehicle from the surrounding vehicle, a display that displays a road guidance map (including information about a place of interest) included in the road guidance information or displays the information about the state of the host vehicle, and a sound output device that outputs road guidance voice information (a road guidance voice message) included in the road guidance information.

The connection device 50 is a module that provides an interface with a vehicle network. The connection device 50 allows the controller 60 to obtain various pieces of information or data from the vehicle network. For example, the controller 60 may obtain the speed, the steering angle, and the angular velocity of the vehicle through the vehicle network. Here, the vehicle network may include a Controller Area Network (CAN), a Local Interconnect Network (LIN), FlexRay, Media Oriented Systems Transport (MOST), Ethernet, or the like.

The controller 60 performs overall control to allow the components to normally perform functions thereof. The controller 60 may be implemented in the form of hardware or software, or in a combination thereof. The controller 60 may be implemented with, but is not limited to, a microprocessor.

The controller 60 may perform various controls in a process of adjusting the height of the vehicle (the vehicle height) depending on the type of road when it rains, operating the suspension 200 in the soft mode when the vehicle travels straight ahead, operating the suspension 200 in the hard mode when the vehicle turns a corner, and adjusting operating time of the suspension 200 based on the lateral acceleration of the vehicle.

The controller 60 may determine whether it rains, based on a rain signal (a signal for informing of a rainy condition) that is obtained from the rain sensor 20 and a wiper operating signal and a washer-fluid dispensing signal that are obtained from the multi-function switch 30. That is, when the rain signal is input from the rain sensor 20 and the wiper operating signal is input from the multi-function switch 30, the controller 60 may determine that it rains. When the rain signal is input from the rain sensor 20 and the wiper operating signal and the washer-fluid dispensing signal are input from the multi-function switch 30, the controller 60 may determine that it does not rain.

When the rain signal is input from the rain sensor 20, the controller 60 may determine that it rains. However, because the accuracy declines, the controller 60 may raise the accuracy in consideration of the wiper operating signal. At this time, the controller 60 may additionally consider the washer-fluid dispensing signal to prevent wrong decision depending on dispensing of washer fluid.

The controller 60 may obtain, from the navigation device 40, information about a road on which the vehicle travels at present. That is, the controller 60 may recognize whether the road on which the vehicle travels at present is a high-speed road, a low-speed road, a straight road, or a curved road. At this time, the high-speed road may be a straight road or a curved road, and the low-speed road may be a straight road or a curved road.

The controller 60 may obtain the speed, the steering angle, and the angular velocity of the vehicle through the vehicle network.

When the vehicle travels on a high-speed road in the event of rain, the controller 60 may lower the height of the vehicle by 30 mm by transferring a first adjustment value (e.g., −30 mm) to the suspension 200 to increase the contact force between the tires and the road surface. That is, the controller 60 may control the suspension 200 to lower the height of the vehicle by 30 mm.

When the vehicle travels on a low-speed road in the event of rain, the controller 60 may lower the height of the vehicle by 15 mm by transferring a second adjustment value (e.g., −15 mm) to the suspension 200 to increase the contact force between the tires and the road surface. That is, the controller 60 may control the suspension 200 to lower the height of the vehicle by 15 mm.

When the vehicle travels on a straight road in the event of rain, the controller 60 may operate the suspension 200 in the soft mode to increase the contact force between the tires and the road surface.

When the vehicle travels on a curved road in the event of rain, the controller 60 may operate the suspension 200 in the hard mode to increase the contact force between the tires and the road surface. At this time, the controller 60 may adjust hard-mode operating time of the suspension 200, based on the lateral acceleration of the vehicle. For example, the controller 60 may operate the suspension 200 in the hard mode at the time when the lateral acceleration of the vehicle exceeds a reference value (e.g., 3G).

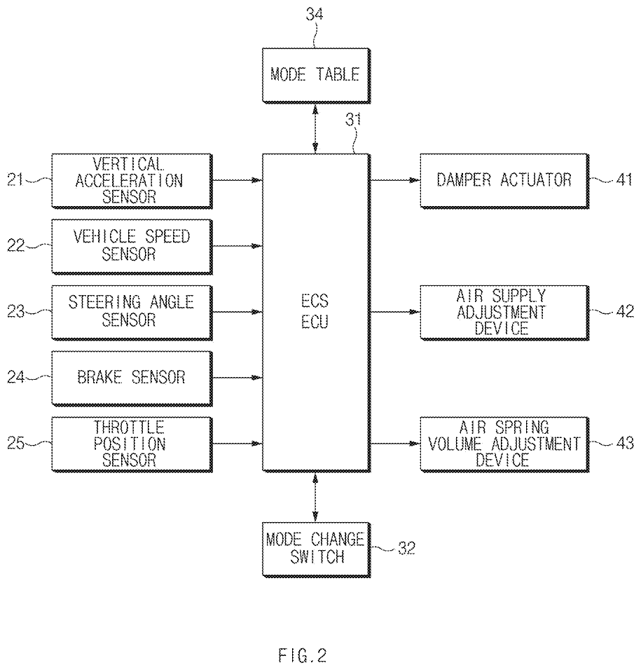

Hereinafter, a configuration of the suspension 200 will be described with reference to FIG. 2.

FIG. 2 is a view illustrating a configuration of an electronically controlled suspension used in the present disclosure.

As illustrated in FIG. 2, the Electronically Controlled Suspension (ECS) used in the present disclosure may include a vertical acceleration sensor 21 that is attached to a vehicle body above each vehicle wheel and that measures the behavior of the vehicle wheel, a vehicle speed sensor 22, a steering angle sensor 23, a brake sensor 24, a throttle position sensor 25, an Electronic Control Unit (ECS ECU) 31, a mode change switch 32 that applies a mode setting key signal (e.g., a hard-mode or soft-mode setting key signal) in response to a driver's button operation, a mode table 34 in which a spring rate adjustment range in the hard mode is recorded, a damper actuator 41 that controls the damping force of a damper installed between the vehicle body and each axle based on a damping-force control signal of the electronic control unit 31, an air supply adjustment device 42 that supplies compressed air in an air tank to a rubber tube of an air spring, or releases air in the rubber tube, based on an air supply control signal of the electronic control unit 31, and an air spring volume adjustment device 43 that adjusts the spring rate of the air spring by adjusting a pressure working volume of the air spring by opening/closing a volume control valve of the air spring based on a valve control signal of the electronic control unit 31.

The electronic control unit 31 generates a damping-force control signal based on information from the sensors 21 to 25, and the damper actuator 41 improves ride comfort and adjustment stability by varying motion characteristics of the damper in real time based on the generated damping-force control signal. That is, the damper may be a continuously variable damper having a variable valve attached to a side surface thereof, and two damping adjustment valves may be installed in the variable valve assembly and may separately control a damping force in a tension/compression stroke.

The air supply adjustment device 42 fills the rubber tube of the air spring with compressed air based on an air supply control signal generated by the electronic control unit 31, and when a piston rod is repeatedly extended and compressed depending on travel of the vehicle, the rubber tube performs a vibration damping action by performing the function of the air spring that moves up and down. In addition, when the rubber tube is compressed due to a large load on the vehicle, the air supply adjustment device 42 may restore the rubber tube by injecting compressed air from the air tank into the rubber tube.

The electronic control unit 31 may have a control algorithm for performing ride comfort control logic and anti-roll control logic. The ride comfort control logic is sky-hook control logic that adjusts a damping force mode from a hard mode to a soft mode through a variable valve for tension in a tension stroke, in which the vehicle body is raised, and adjusts the damping force mode from the soft mode to the hard mode through a variable valve for compression in a compression stroke, in which the vehicle body is lowered. The ride comfort control logic controls vehicle motion to improve ride comfort. The anti-roll control logic may suppress roll motion of the vehicle by increasing the damping force of the damper when the vehicle is steered. To detect the driver's steering input and control a transient region of vehicle body behavior, the anti-roll control logic detects steering angular velocity by receiving a signal from the steering angle sensor 23, detects a change in lateral acceleration and a roll value in consideration of the steering angular velocity and the vehicle speed from the vehicle speed sensor 22, and adjusts the damping force of the damper based on the lateral acceleration change and the roll value.

Furthermore, when lateral motion of the vehicle is detected by the anti-roll control logic, the electronic control unit 31 outputs a valve control signal for control of the volume control valve to prevent a roll phenomenon in which the vehicle body is inclined in an outward direction with respect to a cornering direction by a centrifugal force.

Then, based on the valve control signal of the electronic control unit 31, the air spring volume adjustment device 43 raises the spring rate of an air spring on the side where the vehicle is inclined, by decreasing the pressure working volume of the air spring by instantaneously closing the volume control valve and lowers the spring rate of an air spring on the opposite side by increasing the pressure working volume of the air spring through a volume expander by instantaneously opening the volume control valve, thereby preventing the vehicle from being excessively inclined.

Furthermore, the electronic control unit 31 outputs a valve control signal for control of the volume control valve to represent suspension characteristics of the vehicle depending on a mode setting range tabulated in the mode table 34 in response to a mode setting key signal of the mode change switch 32.

Then, the air spring volume adjustment device 43 forcibly sets suspension characteristics of the vehicle by adjusting the spring rate in a preset range by opening/closing the volume control valve depending on the valve control signal of the electronic control unit 31.

For example, when a hard-mode setting key signal is applied from the mode change switch 32, the air spring volume adjustment device 43 sets suspension characteristics of the vehicle to a hard mode by raising the spring rate by closing the volume control valve based on the valve control signal of the electronic control unit 31. That is, the hard mode is for setting suspension characteristics of the vehicle to a sport mode focused on driving performance rather than ride comfort.

In contrast, when a soft-mode setting key signal is applied from the mode change switch 32, the air spring volume adjustment device 43 sets suspension characteristics of the vehicle to a soft mode by lowering the spring rate by opening the volume control valve based on the valve control signal of the electronic control unit 31. That is, the soft mode is for setting suspension characteristics of the vehicle to a normal mode focused on ride comfort rather than driving performance.

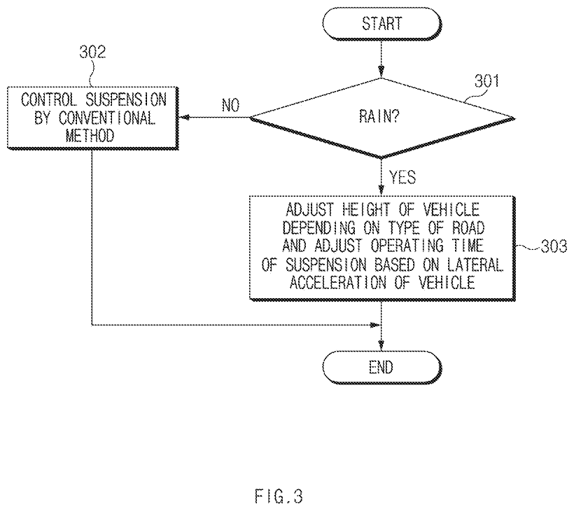

FIG. 3 is a flowchart illustrating a vehicle suspension control method according to an embodiment of the present disclosure.

First, the controller 60 determines whether it rains or not (301).

When it is determined that it does not rain (301), the controller 60 controls the suspension by a conventional method (302).

When it is determined that it rains (301), the controller 60 adjusts the height of the vehicle depending on the type of road and adjusts operating time of the suspension based on lateral acceleration of the vehicle (303).

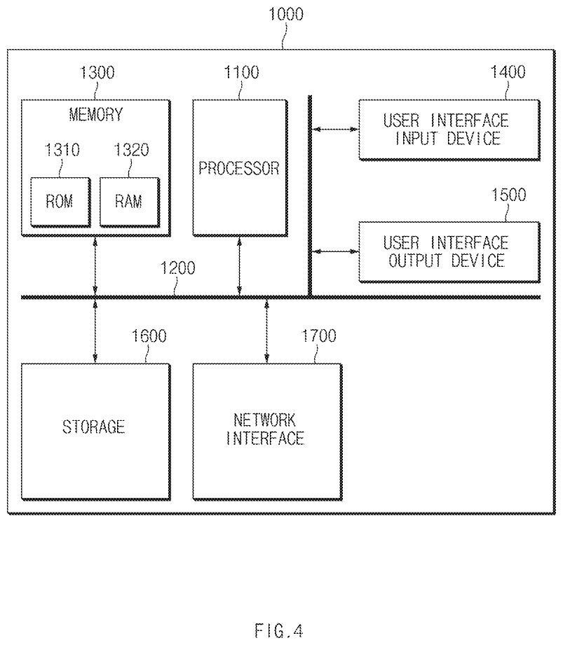

FIG. 4 is a block diagram illustrating a computing system for executing the vehicle suspension control method according to an embodiment of the present disclosure.

Referring to FIG. 4, the above-described vehicle suspension control method according to the embodiment of the present disclosure may be implemented through the computing system. The computing system 1000 may include at least one processor 1100, a memory 1300, a user interface input device 1400, a user interface output device 1500, storage 1600, and a network interface 1700, which are connected with each other via a system bus 1200.

The processor 1100 may be a Central Processing Unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an Application Specific Integrated Circuit (ASIC). The ASIC may reside within a user terminal. In another case, the processor 1100 and the storage medium may reside in the user terminal as separate components.

As described above, according to the embodiments of the present disclosure, the vehicle suspension control apparatus and method may adjust the height of a vehicle (the vehicle height) depending on the type of road when it rains, may operate suspension in a soft mode when the vehicle travels straight ahead, may operate the suspension in a hard mode when the vehicle turns a corner, and may adjust operating time of the suspension based on lateral acceleration of the vehicle, thereby improving a contact force between a tire of the vehicle and a road surface when it rains.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for controlling a suspension of a vehicle, the apparatus comprising:
the electronically controlled suspension arranged between wheels and a vehicle body and configured to increase or decrease a contact force between a tire of the vehicle and a road surface; and
a controller configured to:
adjust a height of the vehicle depending on a type of road when it rains by controlling the suspension, and
adjust an operating time of the suspension based on a lateral acceleration of the vehicle.

2. The apparatus of claim 1, wherein the controller adjusts the height of the vehicle by transferring a first adjustment value to the suspension when the vehicle travels on a high-speed road in the event of rain and by transferring a second adjustment value to the suspension when the vehicle travels on a low-speed road in the event of rain.

3. The apparatus of claim 1, wherein the controller adjusts a hard-mode operating time of the suspension based on the lateral acceleration of the vehicle when the vehicle travels on a curved road in the event of rain.

4. The apparatus of claim 1, wherein, when the vehicle travels on a curved road in the event of rain, the controller sets a reference value that is lower than that at ordinary time and operates the suspension in a hard mode earlier than usual.

5. The apparatus of claim 1, further comprising a rain sensor configured to output a rain signal when water droplets are detected on a windshield of the vehicle,
wherein the controller determines whether it rains or not, based on the rain signal from the rain sensor.

6. The apparatus of claim 1, further comprising:
a rain sensor configured to output a rain signal when water droplets are detected on windshield glass of the vehicle; and
a multi-function switch configured to output a wiper operating signal,
wherein the controller determines whether it rains, based on the rain signal from the rain sensor and the wiper operating signal from the multi-function switch.

7. The apparatus of claim 1, further comprising:
a rain sensor configured to output a rain signal when water droplets are detected on a windshield of the vehicle; and
a multi-function switch configured to output a wiper operating signal and a washer-fluid dispensing signal,
wherein the controller determines whether it rains, based on the rain signal from the rain sensor and the wiper operating signal and the washer-fluid dispensing signal from the multi-function switch.

8. The apparatus of claim 1, wherein the controller collects, from a navigation device, information about a road on which the vehicle travels.

9. The apparatus of claim 1, wherein the controller calculates the lateral acceleration by using a speed, a steering angle, and an angular velocity of the vehicle obtained through a vehicle network.

10. A method for controlling a suspension of a vehicle, the method comprising:
determining whether it rains;
adjusting a height of the vehicle depending on a type of road upon determining that it rains, by controlling the suspension; and
adjusting an operating time of the suspension based on a lateral acceleration of the vehicle.

11. The method of claim 10, wherein the adjusting a height of the vehicle includes:
adjusting the height of the vehicle by transferring a first adjustment value to the suspension, when the vehicle travels on a high-speed road in the event of rain; and
adjusting the height of the vehicle by transferring a second adjustment value to the suspension, when the vehicle travels on a low-speed road in the event of rain.

12. The method of claim 10, wherein the adjusting an operating time of the suspension includes adjusting a hard-mode operating time of the suspension based on the lateral acceleration of the vehicle, when the vehicle travels on a curved road in the event of rain.

13. The method of claim 10, wherein the adjusting an operating time of the suspension includes setting a reference value that is lower than that at ordinary time and operating the suspension in a hard mode earlier than usual, when the vehicle travels on a curved road in the event of rain.

14. The method of claim 10, wherein the determining whether it rains includes determining whether it rains, based on a rain signal from a rain sensor.

15. The method of claim 10, wherein the determining whether it rains includes determining whether it rains, based on a rain signal from a rain sensor and a wiper operating signal from a multi-function switch.

16. The method of claim 10, wherein the determining whether it rains includes determining whether it rains, based on a rain signal from a rain sensor and a wiper operating signal and a washer-fluid dispensing signal from a multi-function switch.

17. The method of claim 10, wherein the adjusting a height of the vehicle includes collecting, from a navigation device, information about a road on which the vehicle travels.

18. The method of claim 10, wherein the adjusting an operating time of the suspension includes:
calculating the lateral acceleration by using a speed, steering angle and an angular velocity of the vehicle obtained through a vehicle network.
